(19) United States
(12) Patent Application Publication
(10) Pub. No.: US 2025/0067850 A1
(43) Pub. Date: Feb. 27, 2025

(54) SYNCHRONIZING OPERATIONS OF SENSORS BASED ON SENSOR STATES

(71) Applicant: GM Cruise Holdings LLC, San Francisco, CA (US)

(72) Inventors: Sathya Narayanan Kasturi Rangan, Milpitas, CA (US); Pulkit Budhiraja, San Mateo, CA (US); Evan McNeil, Pleasanton, CA (US); Sandeep Gangundi, San Jose, CA (US)

(21) Appl. No.: 18/455,169

(22) Filed: Aug. 24, 2023

(51) Int. Cl. G01S 7/481; G01S 17/86

(52) U.S. Cl. CPC G01S 7/4817; G01S 17/86

(57) ABSTRACT

Systems and techniques are provided for synchronizing sensor operations. An example method includes determining a frequency of each scan cycle of a sensor configured to scan different regions of space; based on the frequency, a field-of-view (FOV) of the sensor, and a FOV of an additional sensor, determining an amount of time between a state of a first scan cycle of the sensor in which a point within the FOV of the sensor is aligned with a point within the FOV of the additional sensor and a state of a second scan cycle in which the point within the FOV of the sensor is aligned with the point within the FOV of the additional sensor; determining a time offset based on the amount of time; and sending, to the additional sensor, a signal configured to trigger the additional sensor to capture data at/after time intervals defined by the time offset.

### TECHNICAL FIELD

The present disclosure generally relates to synchronizing operations of multiple sensors. For example, aspects of the present disclosure relate to techniques and systems for triggering sensor data capturing operations of a sensor based on a field-of-view (FOV) of one or more additional sensors.

### BACKGROUND

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, an image sensor of a camera device can be used to capture frames (e.g., video frames and/or still pictures/images) depicting a target(s) from any electronic device equipped with an image sensor. As another example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR. In some cases, a LIDAR can be configured to rotate about an axis of the LIDAR in order to collect LIDAR data for rotation of the LIDAR, such as a full rotation (e.g., 360 degrees) or a partial rotation of the LIDAR. The rotation of the LIDAR can allow the LIDAR to achieve a larger field-of-view (FOV) and thus collect revolutions of LIDAR data that have a greater area of coverage.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, according to some examples of the present disclosure;

FIG. 2 is a diagram illustrating an example synchronization of sensor operations performed by different sensors, according to some examples of the present disclosure;

FIG. 3 is a diagram illustrating example of sensor scans and various synchronization times for sensors to capture sensor data while their field-of-views are aligned with a field-of-view of a light detection and ranging sensor, according to some examples of the present disclosure;

FIG. 4 is a flowchart illustrating an example process for synchronizing data capturing operations of multiple sensors, according to some examples of the present disclosure; and

FIG. 5 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of the subject matter of the application. However, it will be apparent that various aspects and examples of the disclosure may be practiced without these specific details. The figures and description are not intended to be restrictive.

The ensuing description provides examples and aspects of the disclosure, and is not intended to limit the scope, applicability, or configuration of the disclosure. Rather, the ensuing description of the examples and aspects of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, an image sensor of a camera device can be used to capture frames (e.g., video frames and/or still pictures/images) depicting a target(s) from any electronic device equipped with an image sensor. As another example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR. In some cases, a LIDAR, such as a spinning LIDAR, can be configured to rotate about an axis of the LIDAR while collecting LIDAR data for different regions of space. The rotation of the LIDAR can allow the LIDAR to achieve a larger field-of-regard (FOR) based on the field-of-view (FOV) of the LIDAR from different positions during a scan cycle and thus collect revolutions of LIDAR data that have a greater area of coverage.

In some applications, sensor data from different sensors can be fused together (e.g., combined/merged) for specific processing and/or analysis. Fusing sensor data from different sensors can be beneficial as the fused data can provide a greater amount of information and/or insights than sensor data from a single sensor. Moreover, the fused data can be processed by specific software systems (e.g., artificial intelligence (AI) models, machine learning (ML) models, software applications, etc.) to generate outputs used for various tasks. For example, fused data from different sensors can be processed by a software stack(s) of an autonomous vehicle (AV) to generate object detection outputs, recognition outputs, object tracking outputs, classification outputs, prediction outputs, planning outputs, generative outputs, control outputs, and/or navigation outputs, among other outputs.

In some cases, sensor data from different types of sensors can be fused together in part to leverage advantages from each of the different types of sensors. For example, cameras are generally better at capturing visual information than other sensors, while LIDARs are generally better at capturing state information about a scene and/or an object in a scene, such as depth and ranging information (e.g., proximity/distance information), location information, motion information, etc. Thus, the combination of data from a camera and a LIDAR can provide more information, insights, and/or advantages than either the data from the camera or the LIDAR alone.

In general, to fuse data from different sensors, the data from the different sensors may need to be synchronized or aligned (e.g., have aligned or overlapping coverage). In other words, to fuse data from different sensors, the data from the different sensors may not to correspond to a same region of space or have overlapping coverage. However, as previously noted, in some cases, some sensors, such as a LIDAR, can be configured to collect sensor data from different positions, angles, and/or directions as the sensor rotates about an axis of the sensor. Other types of sensors may similarly collect data from different positions, directions, and/or angles. In such cases, it can be very difficult to fuse data from such sensors with data from other sensors (e.g., data from a rotating LIDAR and a camera) as at least some of the data from the sensors may be misaligned in terms of the regions in space that the data cover, depict, represent, and/or measure.

For example, given the different regions of space scanned by a rotating LIDAR as the LIDAR rotates, it can be very difficult to fuse the data from the LIDAR with data from another sensor, such as a camera sensor, as the coverage of (e.g., the regions in space sensed/measured in) the data from the LIDAR and the data from the other sensor can differ. Thus, the coverage of the data from the other sensor and the coverage of the data captured by the LIDAR from different angles of rotation can be different (e.g., misaligned) due to the different regions of space covered by the data from the other sensor and the data from the LIDAR obtained while the LIDAR rotates. As a result, at least some of the data from the LIDAR and the data from the other sensor can be misaligned and thus difficult to fuse in an accurate and/or reliable manner and/or without errors or inconsistencies in the resulting data.

In some aspects, systems, apparatuses, processes (also referred to as methods), and computer-readable media (collectively referred to as “systems and techniques”) are described herein for synchronizing operations of a sensor, such as camera record operations, with operations of another sensor, such as a LIDAR, based on a state and/or setting of the other sensor. For example, the systems and techniques described herein can trigger camera recording operations based on a FOV of a LIDAR and a frequency of rotation of the LIDAR. In some examples, the systems and techniques described herein can trigger a camera to record image data (e.g., one or more video frames and/or still pictures/images) when a FOV of the camera is at least partially aligned with a FOV of a moving (e.g., rotating/spinning) LIDAR. This way, the coverage of the image data from the camera can at least partially overlap with (e.g., be aligned with) the LIDAR data captured by the moving LIDAR when the image data from the camera was recorded. In other examples, the systems and techniques described herein can trigger another type of sensor device to capture sensor data when a FOV of the sensor device is at least partially aligned with a FOV of a moving sensor. This way, the coverage of the sensor data from the sensor device can at least partially overlap with (e.g., be aligned with) the data captured by the moving sensor when the sensor data from the sensor device was captured.

In some cases, the systems and techniques described herein can trigger a sensor to capture sensor data based on the FOV of the sensor from a given pose of the sensor and the FOV of a moving sensor at a particular time during a scan cycle of the moving sensor in which the moving sensor collects data for different regions of space that together represent a field-of-regard (FOR) of the moving sensor for a scan cycle. For example, the systems and techniques described herein can determine the frequency of rotation (and/or other motion) of a LIDAR, the FOV of the LIDAR from a given position (e.g., the angle of the FOV of the LIDAR from any given position), and the FOV of another sensor from a given position (e.g., the angle of the FOV of the sensor from any given position). The systems and techniques described herein can use the frequency of rotation (and/or other motion) of the LIDAR, the FOV of the LIDAR from a given position, and the FOV of the sensor from a given position to determine when to trigger the sensor to capture sensor data so that the sensor data is aligned with (e.g., has a same or overlapping area of coverage as) data captured by the LIDAR at a time when the FOV of the LIDAR is aligned with (e.g., matches or overlaps with) the FOV of the sensor. This way, such data from the LIDAR and the sensor can be accurately and reliably fused together for further processing and/or analysis.

In some examples, when triggering the sensor to capture sensor data, the systems and techniques described herein can account for a delay between the time a signal to capture sensor data is sent to the sensor (or is received by the sensor) and the time when the sensor actual begins capturing sensor data (and/or between the time that the sensor initiates a data capture operation and actually begins capturing sensor data). For example, the systems and techniques described herein can determine a delay between the time that a camera recording is activated (e.g., the time that a signal to record is sent to or received by the camera and/or the time that the camera initiates the recording operation) and the time when the camera begins recording a frame (e.g., a video frame or a still image). The systems and techniques described herein can use the delay to determine when to activate the camera recording such that the camera records the frame while the FOV of the camera and the FOV of the LIDAR (and thus the coverage of the frame and the LIDAR data captured from such FOVs) are at least partially aligned (e.g., match, overlap).

For example, the systems and techniques described herein can activate the camera recording a certain amount of time before the FOV of the camera and the FOV of the LIDAR are predicted to be fully or partially aligned. The amount of time can be based on the delay so that by the time that the camera begins recording a frame, the FOV of the camera is fully or partially aligned with the FOV of the LIDAR. In this way, the systems and techniques described herein can time the activation of the camera recording such that the FOV of the camera is fully or partially aligned with the FOV of the LIDAR (e.g., during the movement/rotation of the LIDAR) when the camera begins recording the frame, and thus ensure full or partial alignment of the data captured by the camera and the LIDAR while their FOVs are fully or partially aligned.

In some aspects, the systems and techniques described herein can determine the FOV of a sensor from a particular position, the rate or frequency of motion (e.g., rotation) of another sensor (e.g., a LIDAR), and the FOV of the other sensor at a particular time (e.g., a current time, a past time such as a time at a particular position of the other sensor, etc.). The systems and techniques described herein can predict when a region (e.g., a center) of the FOV of the sensor and a corresponding region (e.g., a center) of the FOV of the other sensor will be aligned based on the FOV of the sensor, the rate or frequency of motion of the other sensor, a frequency of each scan cycle of the other sensor, and/or the FOV of the other sensor at the particular time (and optionally a delay between activation of the sensor data capturing operations and actually capturing the sensor data). The systems and techniques described herein can trigger the sensor to capture sensor data at a certain time predicted to cause the sensor to capture the sensor data while the FOV of the sensor is aligned with the FOV of the other sensor as the other sensor moves (e.g., rotates) during operation (e.g., during each scan cycle).

In some cases, the systems and techniques described herein can determine a FOV of a moving sensor at a particular time (e.g., a current time) and relative to a FOV of another sensor, and predict when the FOV of the moving sensor will be aligned with (fully or partially) the FOV of the other sensor based on the relative FOVs of the moving and the other sensor at the particular time and the rate or frequency of motion (e.g., rotation) of the moving sensor. The systems and techniques described herein can then trigger the other sensor to capture sensor data at a time when the FOV of the moving sensor is predicted to align with the FOV of the other sensor. This way, the systems and techniques described herein can ensure alignment (full or partial) of the sensor data from the moving sensor and the data captured by the other sensor while the FOVs of the moving sensor and the other sensor are aligned. For example, the systems and techniques described herein can determine the angle of a FOV of a moving (e.g., rotating) LIDAR at any given time and the rate or frequency of movement of the LIDAR, and determine when the FOV of the LIDAR will align with the FOV of another sensor based on the angle of the FOV of the LIDAR and the rate or frequency of movement of the LIDAR.

To illustrate, the systems and techniques described herein can use the rate or frequency of rotation of a LIDAR to determine how much time it will take the LIDAR to rotate from an angle of the LIDAR at the particular time within a scan cycle to an angle in which the FOV of the LIDAR and the FOV of a camera will align. This way, the systems and techniques described herein can predict when the FOV of the LIDAR will be aligned with the FOV of the camera, and determine when to trigger the camera to record a frame based on the time when the FOV of the LIDAR is predicted to align with the FOV of the camera (e.g., based on an amount of time until the FOV of the LIDAR and the FOV of the camera are aligned).

The systems and techniques described herein can be used to trigger sensors to capture data when their FOVs are predicted to be in alignment (full or partial) so the captured sensor data is fully or partially aligned. For explanation purposes, the systems and techniques described herein are discussed with respect to examples of a sensor, such as a camera sensor, and a LIDAR that rotates while it captures LIDAR data. However, the systems and techniques described herein can be used to determine when to trigger any other types of sensors to capture sensor data while their FOVs are aligned (fully or partially), where at least one of the sensors can capture data for different regions of space during a scan cycle (e.g., as a result of sensor movement and/or repositioning). For example, the systems and techniques described herein can be used to determine when to trigger a sensor (e.g., a LIDAR, a camera sensor, a radio detection and ranging (RADAR) sensor, an ultrasonic sensor, a time-of-flight (TOF) sensor, etc.) to capture sensor data while the sensor's FOV is aligned with (fully or partially) the FOV of one or more different sensors (e.g., one or more LIDARs, cameras, RADARs, ultrasonic sensors, TOF sensors, etc.), where at least one of the sensors capture data for different regions of space during a scan cycle (e.g., as a result of sensor movement and/or repositioning).

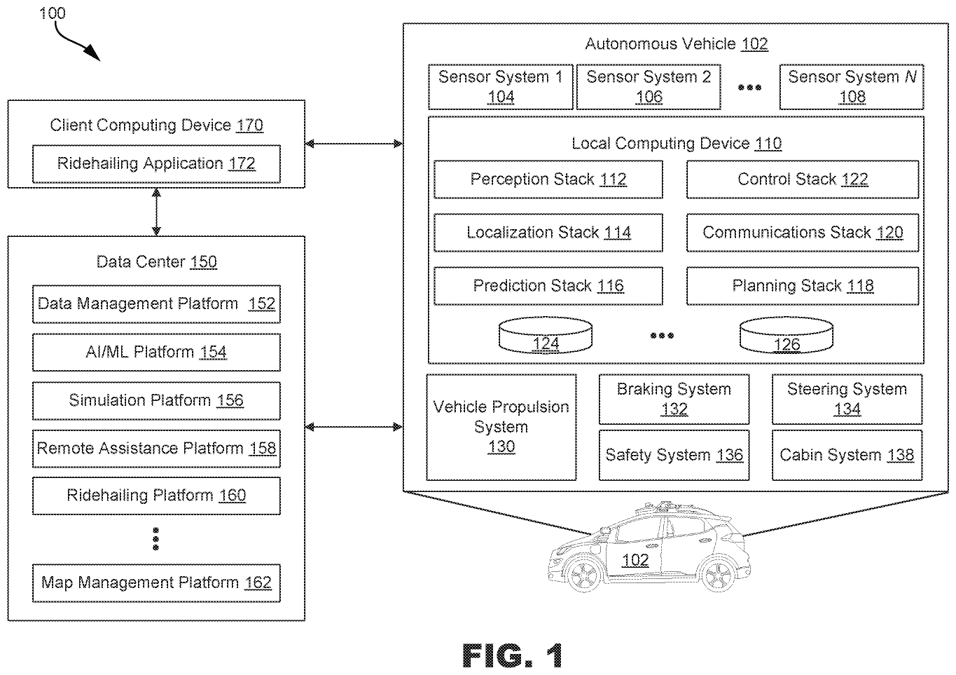

Various examples of the systems and techniques described herein for processing data are illustrated in FIG. 1 through FIG. 5 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs (e.g., AV 102), Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehailing application 172 to enable passengers to view the AV 102 in transit to a pick-up or drop-off location, and so on.

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

In some examples, the local computing device 110 of the AV 102 can include an ADSC. Moreover, the local computing device 110 can be configured to implement the systems and techniques described herein. For example, the local computing device 110 can be configured to implement the streaming LIDAR processing described herein.

As previously explained, a LIDAR preprocessing pipeline that involves waiting for a full revolution of LIDAR data to begin preprocessing the LIDAR data can lead visual artifacts. For example, a LIDAR system (e.g., sensor system 104, sensor system 106, sensor system 108) can capture a full revolution of LIDAR data (e.g., a full LIDAR scan) every n interval of time, where n is a positive number greater than zero. Thus, the data collected at the start of the LIDAR scan is n amount of time older than the data collected at the end of the LIDAR scan, where the n amount of time is based on the n interval of time associated with each full revolution of LIDAR data. To illustrate, if it takes the LIDAR system 100 milliseconds (ms) to capture a full revolution of LIDAR data, then the LIDAR data collected at the start of the LIDAR scan is 100 ms older than the LIDAR data collected at the end of the LIDAR scan. When a full revolution of LIDAR data is wrapped around to create a 360° representation, a split plane can form where the start and the end of the LIDAR data join as the LIDAR data on one side of the split plane is 100 ms older than the LIDAR data on the other side of the split plane.

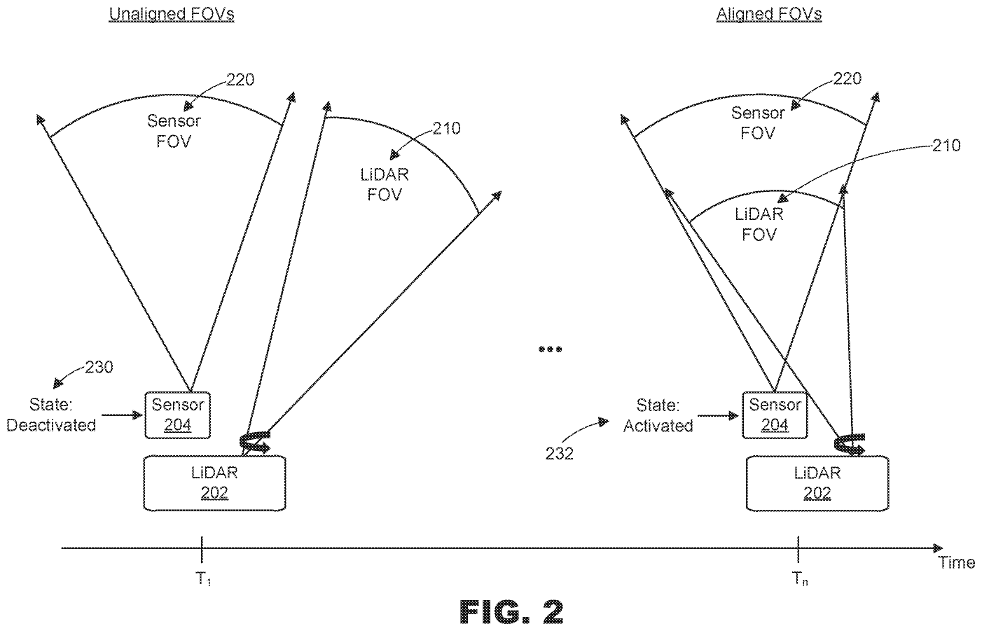

FIG. 2 is a diagram illustrating an example synchronization of sensor operations performed by different sensors, according to some examples of the present disclosure. The sensor operations can include capturing/collecting sensor data such as image data, measurements, point cloud data, etc. In this example, the synchronization of sensor operations can include triggering the sensor 204 to capture sensor data when the field-of-view (FOV) of a sensor 204 is at least partially aligned with a FOV of a LIDAR 202 configured to move during a scan cycle (e.g., configured to rotate during a scan cycle). As used herein, an FOV of a sensor (e.g., LIDAR 202, sensor 204) refers to a region of space that can be sensed and/or observed by the sensor at a given moment, from a given sensing direction, and/or from a given pose of the sensor. Thus, the FOVs of a sensor when capturing data from different sensing directions, positions, and/or angles can vary in terms of the regions of space covered by the FOVs, even if the size/angle of the FOVs is/are the same as such FOVs are relative to the different directions, positions, and/or angles.

For example, the LIDAR 202 can include a movable LIDAR that moves (e.g., rotates about an axis of the LIDAR 202) as it collects LIDAR data during a scan cycle. The LIDAR 202 can have a field of regard (FOR) that represents the total area of space (e.g., of a scene) that can be measured, perceived and/or sensed by the LIDAR 202 during a scan cycle. The FOR can include a set of FOVs of the LIDAR 202 from different scanning positions, directions, and/or angles of the LIDAR 202 during the scan cycle. Each FOV of the set of FOVs can cover different regions of space, which may or may not have some overlap, based on different scanning positions, directions, and/or angles associated with the set of FOVs. The different scanning positions, directions, and/or angles of the LIDAR 202 result from movement of the LIDAR 202 during each scan cycle, such as rotation of the LIDAR 202 about an axis of the LIDAR 202 during a scan cycle, and can result in the FOVs of the LIDAR 202 during a scan cycle covering different regions of space. During a scan cycle, the LIDAR 202 can collect LIDAR data from the different positions, directions, and/or angles based on the movement of the LIDAR 202 (e.g., via rotational motion, translational or linear motion, and/or any other type of motion) to obtain LIDAR data for an area corresponding to the FOR of the LIDAR 202, which includes the different regions of space. The FOR of the LIDAR 202 can include the FOVs of the LIDAR 202 during a scan cycle, and each of the FOVs can cover a different region of space.

The sensor 204 can include any sensor such as a camera sensor, another LIDAR sensor, a RADAR sensor, an acoustic sensor, a time-of-flight (TOF) sensor, etc. In some cases, the sensor 204 can be a stationary sensor with a FOV that includes an area of a scene that can be measured, sensed, perceived, etc., by the sensor 204 from a pose of the sensor 204 (e.g., from a position and/or angle of the sensor 204). In other cases, the sensor 204 can include a movable sensor or a sensor on a platform that moves the sensor 204 to obtain sensor data from the sensor 204 for different areas of space (e.g., for different FOVs of the sensor 204 corresponding to different positions/poses of the sensor 204 resulting from movement of the sensor 204). Given the pose of the sensor 202, the angle of the FOV of the sensor 204, the different poses and FOVs (e.g., the different coverage) of the LIDAR 202 during a scan cycle, and the angle of a FOV of the LIDAR 202, the FOV of the sensor 204 may be misaligned with the FOV of the LIDAR 202 during one or more portions of a scan cycle of the LIDAR 202. Accordingly, the sensor data captured by the sensor 204 may not always be aligned with at least some of the data captured by the LIDAR 202 during a scan cycle of the LIDAR 202.

For example, when the FOV of the LIDAR 202 is not aligned with the FOV of the sensor 204 during a scan cycle of the LIDAR 202, the data from the LIDAR 202 may not measure, depict, describe, and/or sense a same region in space (e.g., in a scene) as the data from the sensor 204. This can result in unaligned data from the LIDAR 202 and the sensor 204, which can prevent or increase the difficult in accurately or effectively fusing the data from the LIDAR 202 and the sensor 204 for further processing. To ensure that the data from the sensor 204 is aligned with the data from the LIDAR 202 (e.g., the data from the sensor 204 is captured by the sensor 204 while the FOV of the sensor 204 is aligned with a FOV of the LIDAR 202 within the FOR of the LIDAR 202), the sensor operations of the LIDAR 202 and the sensor 204 can be synchronized as described herein.

The synchronization of sensor operations of the LIDAR 202 and the sensor 204 can include triggering the sensor 204 to capture sensor data when a FOV of the LIDAR 202 is at least partially aligned with the FOV of the sensor 204. For example, the frequency of a scan cycle of the LIDAR 202 (e.g., the frequency of movement of the LIDAR 202 for a complete scan cycle of the LIDAR 202), the angle of the FOV of the LIDAR 202 from each position/angle of the LIDAR 202 during the scan cycle, the pose of the sensor 204, and/or the angle of the FOV of the sensor 204 can be used to predict when a center (and/or any other point/region) of the FOV of the LIDAR 202 will align with the center (and/or any other point/region) of the FOV of the sensor 204 during a scan cycle of the LIDAR 202. The predicted time can be used to trigger the sensor 204 to capture sensor data when the FOV of the sensor 204 is aligned with the FOV of the LIDAR 202, so that the data from the sensor 204 measures, depicts, and/or senses the same or overlapping region in space as the data from the LIDAR 202 at the time that the FOV of the LIDAR 202 is aligned with the FOV of the sensor 204. This way, the sensor data captured by the sensor 204 and the LIDAR 202 can be at least partially aligned in terms of their coverage of a scene, and can be fused together for further processing.

For example, when the FOVs of the LIDAR 202 and the sensor 204 are at least partially aligned, the sensor data from the LIDAR 202 and the sensor 204 can depict, measure, describe, sense, and/or represent a same region within a scene or at least overlapping regions within the scene. Such alignment of sensor data can allow the sensor data from the LIDAR 202 and the sensor 204 to be fused (e.g., combined/merged) together (and/or may enable better fusion accuracy and/or performance) and/or can allow the sensor data from the LIDAR 202 to be supplemented with information from the sensor data from the sensor 204.

In the example shown in FIG. 2, the sensors can include the LIDAR 202 and the sensor 204. However, in other examples, the sensors can include any other sensor and/or number of sensors where at least one sensor has different FOVs (e.g., because of movements/scans by the sensor). As previously noted, the LIDAR 202 can perform scans where the LIDAR 202 collects LIDAR data from a set of positions and associated FOVs in order to collect LIDAR data for various regions of a scene. For example, in some cases, the LIDAR 202 can rotate (e.g., a full 360-degree rotation or a partial rotation that is less than 360 degrees) about an axis of the LIDAR 202 and obtain sensor data (e.g., point cloud datasets) as the LIDAR 202 rotates. As the LIDAR 202 rotates, the FOV of the LIDAR 202 can change (e.g., based on the changed angle/position of the LIDAR 202), allowing the LIDAR 202 to capture LIDAR data associated with a FOR of the LIDAR 202 that includes different FOVs of the LIDAR 202. This way, the LIDAR 202 can obtain LIDAR data coverage for different portions of a scene.

In some examples, the LIDAR 202 and the sensor 204 can be implemented by a vehicle, such as the AV 102, which may use the data from the LIDAR 202 and the sensor 204 to navigate a scene, as previously described. In this example, the LIDAR 202 and the sensor 204 can be positioned at different locations on the vehicle (e.g., on the AV 102). The vehicle (e.g., the AV 102) may use the data captured by the LIDAR 202 and the sensor 204 to understand its surroundings. While the synchronization of the LIDAR 202 and the sensor 204 is described herein with respect to a vehicle (e.g., AV 102) implementing such sensors to assist the vehicle to navigate a scene(s), the synchronization of the LIDAR 202 and the sensor 204 can be performed to synchronize sensor operations in any other contexts and/or use cases for implementing the LIDAR 202 and the sensor 204, such as a different type of transportation system, a robotic system, etc.

As further described herein, the sensor 204 can be triggered to collect data when a FOV of the LIDAR 202 is at least partially aligned with a FOV of the sensor 204. For example, as previously noted, as the LIDAR 202 performs a scan, the FOV of the LIDAR 202 can change to allow the LIDAR 202 to capture data from different FOVs corresponding to different angles and/or positions, which can provide coverage for different portions of a scene. The frequency of the LIDAR 202 (e.g., the frequency of rotation, the frequency of FOV changes, the frequency of a scan, etc.), the angle of the FOV of the LIDAR 202 and/or the FOV of the LIDAR 202 from a given position and/or angle during a scan, and the FOV of the sensor 204 can be taken into account to predict when the FOV of the LIDAR 202 will be at least partially aligned with the FOV of the sensor 204. As previously noted, in some cases, the FOV of the LIDAR 202 can be deemed to be aligned with the FOV of the sensor 204 when a center of the FOV of the LIDAR 202 is aligned with a center of a FOV of the sensor 204. In other cases, the FOV of the LIDAR 202 can be deemed to be aligned with the FOV of the sensor 204 when an angle of the FOV of the LIDAR 202 is aligned with an angle of a FOV of the sensor 204 or when the angle of the FOV of the LIDAR 202 overlaps with and/or is within the angle of the FOV of the sensor 204 (or vice versa).

In some cases, a time offset (e.g., an alignment offset) of the sensor 204 and the LIDAR 202 may be calculated and used to synchronize the coverage of data captured by the LIDAR 202 and the sensor 204 in order to optimize an overlap between a plane (e.g., a focal plane, etc.), FOV, and/or coverage of the sensor 204 and a plane, FOV, and/or coverage of the LIDAR 202 at a particular time(s) during a scan cycle of the LIDAR 202. In some examples, the time offset can be determined based on the frequency of a scan cycle of the LIDAR 202 (e.g., the frequency in which the LIDAR 202 moves and collects data from a beginning of a scan cycle until an end of the scan cycle), the angle of a FOV of the LIDAR 202 from a given position/angle of the LIDAR 202 (and/or at any given time during the scan cycle), the angle of a FOV of the sensor 204 from a given position/angle, a center or center plane of the FOV of the LIDAR 202, and/or a center or center plane of the FOV of the sensor 204.

For example, the frequency of a scan cycle of the LIDAR 202 and the angle of the FOV of the LIDAR 202 from any given position and/or angle of the LIDAR 202 during the scan cycle (and/or at any given time during the scan cycle) can be used to predict when the FOV of the LIDAR 202 will be aligned with the FOV of the sensor 204 (e.g., when a center of the FOV of the LIDAR 202 will be aligned with the center of the FOV of the sensor 204). The time when the FOVs of the LIDAR 202 and the sensor 204 are predicted to align can then be used to determine the time offset, which can represent a time and/or interval of time during the scan cycle of the LIDAR 202 when the FOVs of the LIDAR 202 and the sensor 204 will be in alignment.

The time offset can be used to trigger the sensor 204 to capture sensor data when the FOVs of the LIDAR 202 and the sensor 204 are aligned. For example, the time offset can define a delay between sensor data capturing operations of the sensor 204 so the FOV of the sensor 204 is aligned with the FOV of the LIDAR 202 each time that the sensor 204 captures data. In some cases, the time offset can also include a delay between a time when the sensor 204 initiates a data capturing operation (and/or a time when a signal is generated instructing the sensor 204 to initiate the data capturing operation) and a time when the sensor 204 starts obtaining sensor data after initiating the data capturing operation.

For example, if the capabilities and/or configuration of the sensor 204 are such that there is a delay of n amount of time between the time when the sensor 204 initiates an operation to capture sensor data and the time when the sensor 204 actually captures the sensor data, the amount of time defined by the time offset can be reduced by the n amount of time associated with the delay so the sensor 204 is triggered to capture sensor data at n amount of time before the FOV of the LIDAR 202 is aligned with the FOV of the sensor 204 to account for the delay from when the sensor 204 initiates the operation to capture sensor data and the sensor 204 actually obtaining the sensor data. This way, the sensor 204 can be triggered to initiate the operation to capture sensor data at n amount of time before the FOVs of the LIDAR 202 and the sensor 204 are aligned so that the FOVs of the LIDAR 202 and the sensor 204 are aligned when (and/or by the time that) the sensor 204 actually captures/obtains the sensor data. In other words, by accounting for the delay in the time offset, the FOV of the sensor 204 can be aligned with the FOV of the LIDAR 202 at the time that the sensor 204 actually captures/obtains sensor data rather than the time that the sensor 204 initiates the operation to capture sensor data which based on such delay would be before the time when the sensor 204 actually captures the sensor data.

In some cases, the time offset can be adjusted if the LIDAR 202 (or the sensor 204) experiences drift. For example, if there is a change to the frequency of the LIDAR 202, a pose of the LIDAR 202, a FOV of the sensor 204, a pose of the sensor 204, and/or any other misalignment or cause for misalignment between the FOVs of the LIDAR 202 and the sensor 204, the time offset can become more and more inaccurate over time (e.g., the FOVs of the LIDAR 202 and the sensor 204 can become more and more out of synchronization). A computer system, such as the local computing device 110, can detect such drift and trigger an adjustment of the time offset to correct the drift and ensure that the FOVs of the LIDAR 202 and the sensor 204 remain aligned over time during a given portion of each scan cycle of the LIDAR 202.

In some examples, the computer system can detect the drift by comparing the angles of the FOVs of the LIDAR 202 and the sensor 204 at a given time during a scan cycle of the LIDAR 202 and/or from a given position/angle of the LIDAR 202 during the scan cycle. In other examples, the computer system can detect the drift by comparing the centers (or any other points/regions) of the FOVs of the LIDAR 202 and the sensor 204 at a given time during a scan cycle of the LIDAR 202 and/or from a given position/angle of the LIDAR 202 during the scan cycle.

For example, the computer system can compare the angle of coverage of data from the sensor 204 and data from the LIDAR 202 corresponding to a time when the FOVs of the LIDAR 202 and the sensor 204 were predicted to be aligned (e.g., based on the time offset) to determine whether the FOVs of the LIDAR 202 and the sensor 204 (and/or the data from the LIDAR 202 and the sensor 204 at a predicted time of alignment) are misaligned and should be corrected. The computer system can determine a compensation amount (e.g., an amount of time to compensate for the drift), which can be added to or subtracted from the time offset to yield an adjusted time offset that realigns the FOVs of the LIDAR 202 and the sensor 204. The compensation amount can be added to the time offset if the time offset is determined to trigger the sensor 204 to capture data after the FOVs of the LIDAR 202 and the sensor 204 are no longer aligned (e.g., the sensor 204 captures data late relative to the alignment of the FOVs of the LIDAR 202 and the sensor 204), or subtracted from the time offset if the time offset is determined to trigger the sensor 204 to capture data before the FOVs of the LIDAR 202 and the sensor 204 are aligned (e.g., the sensor 204 captures data early relative to the alignment of the FOVs of the LIDAR 202 and the sensor 204).

As another example, the compensation amount can be used to adjust (e.g., delay or move forward) a time when the time offset is applied. For example, if the time offset is determined relative to a time during the scan cycle of the LIDAR 202, such as a beginning of the scan cycle, the time offset can be applied from an earlier time such as a time before the scan cycle of the LIDAR 202 begins (e.g., before a previous scan cycle completes) or a time after the scan cycle begins so that when the time offset is applied to that adjusted time, the time offset will result in realignment of the FOVs of the LIDAR 202 and the sensor 204.

In some cases, the compensation amount used to correct drift can be calculated based on metadata of the sensor data captured by the LIDAR 202 and/or the sensor 204. For example, in some cases, the sensor data from the LIDAR 202 can include metadata (e.g., in a header of the sensor data, etc.) indicating a timestamp when the sensor data was captured and/or the angle of coverage of the sensor data. Such metadata can be used to determine any misalignment between the FOVs of the LIDAR 202 and the sensor 204 at a time when the time offset triggers the sensor 204 to capture sensor data, and a compensation amount that can be used to adjust the time offset to realign the FOVs of the LIDAR 202 and the sensor 204 at a time when the adjusted time offset triggers the sensor 204 to capture sensor data.

As shown in FIG. 2, at time T₁, the FOV 210 of the LIDAR 202 is not aligned with the FOV 220 of the sensor 204. Accordingly, at time T₁, the data capture operation of the sensor 204 is not executed due to the misalignment between the FOV 210 of the LIDAR 202 and the FOV 220 of the sensor 204. The FOV 210 of the LIDAR 202 and the FOV 220 of the sensor 204 are not aligned at T₁ because of the positions, angles, and/or pointing directions of the LIDAR 202 and the sensor 204 at T₁ result in misaligned FOVs. Thus, as shown in this example, the FOV 220 of the sensor 204 and the FOV 210 of the LIDAR 202 are unaligned, and the state 230 of the sensor 204 is deactivated 230 meaning that the sensor 204 is not actively capturing sensor data at T₁. The state 230 of the sensor 204 (e.g., deactivated or activated) as used herein refers to whether the sensor 204 is capturing sensor data (and/or has initiated a data capturing operation).

In some examples, the alignment of the data capturing of the LIDAR 202 and the sensor 204 can be based on a synchronizing calculation used to determine when to trigger the sensor 204 to capture data so the data captured by the sensor 204 (and/or a line-of-sight of the sensor 204) is at least partially aligned with the data captured by the LIDAR 202 (e.g., so the data from the sensor 204 is captured while the FOV of the sensor 204 at least partially aligns with the FOV of the LIDAR 202) and/or a line-of-sight of the LIDAR 202. For example, the synchronization calculation can be used to determine a time offset that can be used to trigger the sensor 204 to capture sensor data when the FOV of the sensor 204 is aligned with the FOV of the LIDAR 202 (e.g., when centers of the FOVs of the LIDAR 202 and sensor 204 are aligned).

In some examples, the synchronization process can determine an amount of time it takes the LIDAR 202 to complete a scan cycle. For example, the synchronization process can determine the amount of time it takes the LIDAR 202 to move (e.g., rotate) during a scan cycle (e.g., based on a LIDAR frequency) from a start location, position, and/or angle of the LIDAR 202 at a beginning of a scan cycle until an end location, position, and/or angle of the LIDAR 202 at an end of the scan cycle. The synchronization process can use the amount of time it takes the LIDAR 202 to complete a scan cycle to determine an interval of time between a time when the center of the FOV of the LIDAR 202 is aligned with the center of the FOV of the sensor 204 during a scan cycle and the time when the center of the FOV of the LIDAR 202 will be aligned with the center of the FOV of the sensor 204 during a next scan cycle. Such interval of time can be used to determine a time offset that can be used to trigger the sensor 204 to capture sensor data when the FOV of the sensor 204 is aligned with the FOV of the LIDAR 202.

At time T₂, the FOV 220 of the sensor 204 is aligned with the FOV 210 of the LIDAR 202. The sensor 204 can be triggered to capture sensor data at time T₂ when the FOV 220 of the sensor 220 is aligned with the FOV 210 of the LIDAR 202 based on a time offset, as further described herein. In some examples, when the FOV 210 of the LIDAR 202 is aligned with the FOV 220 of the sensor 204, the scan/sweep of the LIDAR 202 can be aligned with and/or come across the center of the FOV 220 of the sensor 204, resulting in an optimal sampling time for the sensor 204 so the data from the sensor 204 covers a same or overlapping region in space as the data from the LIDAR 202. Here, since the FOV 220 of the sensor 204 and the FOV 210 of the LIDAR 202 are aligned, the state 232 of the sensor 204 can be activated meaning that the sensor 204 triggered to capture sensor data at T₂ when the FOV 210 of the LIDAR 202 and the FOV 220 of the sensor 204 are aligned.

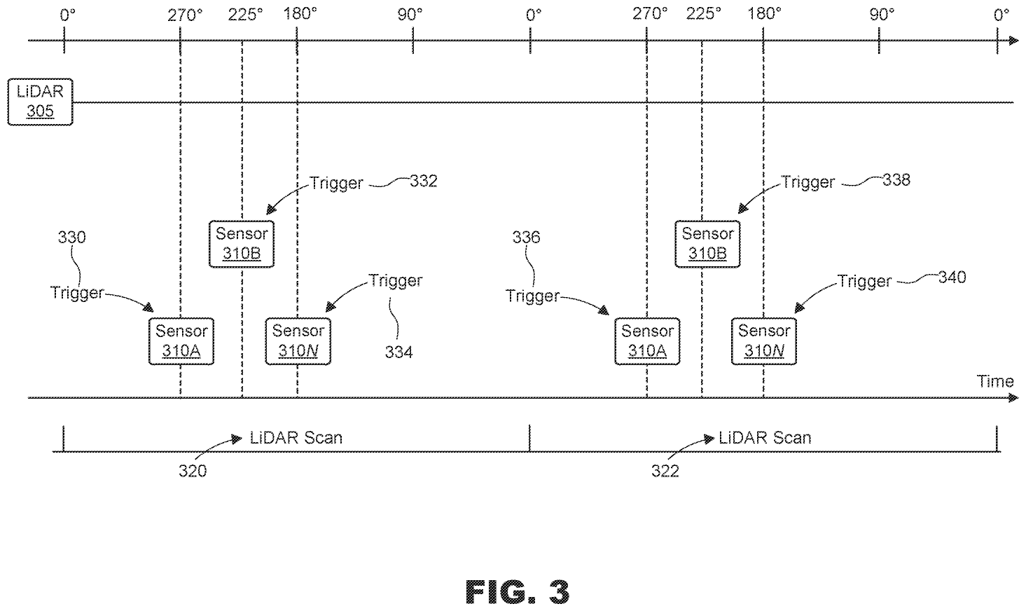

FIG. 3 is a diagram illustrating example of LIDAR scans 320 and 322 and various synchronization times for the sensors 310A, 310B, 310N (collectively “310” hereinafter) to capture sensor data while their FOVs are aligned with a FOV of LIDAR 305. The top trace shows a LIDAR 305 that rotates 360 degrees while collecting sensor data during each scan cycle of the LIDAR 304 (e.g., each scan cycle involves 360 degrees of rotation). When the FOV of the LIDAR 305 is aligned with the FOVs of the sensors 310, a computing device (e.g., local computing device 110 of AV 102) can instruct the sensors 310 to capture sensor data. The computing device can trigger the sensors 310 to capture sensor data based on one or more time offsets calculated as previously described. In some cases, the computing device can trigger the sensors 310 to initiate an operation to capture sensor data prior to the FOVs of the sensors 310 and the FOV of the LIDAR 305 being aligned. The amount of time before the alignment of FOVs for triggering the initiation of the operation to capture sensor data can be based on a respective delay of each sensor from the time that such operation is initiated until the time when the sensor captures/obtains sensor data.

The computing device (e.g., local computing device 110) may determine the trigger times based on the LIDAR sensor frequency. The LIDAR frequency describes the frequency at which the LIDAR completes a scan cycle and/or the rate in which the FOV of the LIDAR 305 changes during a scan cycle. The sensors 310 can be instructed to capture data at a frequency corresponding to a time offset estimated to cause the sensors 310 to capture sensor data when the FOVs of the sensors 310 are aligned with the FOV of the LIDAR 305.

For example, as shown in FIG. 3, the computing device can send a trigger 330 to the sensor 310A that triggers the sensor 310A to capture sensor data when a center of the FOV of the LIDAR 305 is at 270 degrees during the LIDAR scan 320, and again when the center of the FOV of the LIDAR 305 is at 270 degrees during the LIDAR scan 322, which is a subsequent LIDAR scan. When the center of the FOV of the LIDAR 305 is at 270 degrees during the LIDAR scan 320 and the LIDAR scan 322, the center of the FOV of the LIDAR 305 and the center of the FOV of the sensor 310A are predicted to be aligned. Therefore, the sensor data captured by the sensor 310A when the center of the FOV of the LIDAR 305 is at 270 degrees will be in alignment with the data captured by the LIDAR 305 when the center of the FOV of the LIDAR 305 is at 270 degrees.

Similarly, the computing device can send a trigger 332 to the sensor 310B that triggers the sensor 310B to capture sensor data when a center of the FOV of the LIDAR 305 is at 225 degrees during the LIDAR scan 320, and again when the center of the FOV of the LIDAR 305 is at 225 degrees during the LIDAR scan 322. When the center of the FOV of the LIDAR 305 is at 225 degrees during the LIDAR scan 320 and the LIDAR scan 322, the center of the FOV of the LIDAR 305 and the center of the FOV of the sensor 310B are predicted to be aligned. Therefore, the sensor data captured by the sensor 310B when the center of the FOV of the LIDAR 305 is at 225 degrees will be in alignment with the data captured by the LIDAR 305 when the center of the FOV of the LIDAR 305 is at 225 degrees.

Moreover, the computing device can send a trigger 334 to the sensor 310N that triggers the sensor 310N to capture sensor data when a center of the FOV of the LIDAR 305 is at 180 degrees during the LIDAR scan 320, and again when the center of the FOV of the LIDAR 305 is at 180 degrees during the LIDAR scan 322. When the center of the FOV of the LIDAR 305 is at 180 degrees during the LIDAR scan 320 and the LIDAR scan 322, the center of the FOV of the LIDAR 305 and the center of the FOV of the sensor 310N are predicted to be aligned. Therefore, the sensor data captured by the sensor 310N when the center of the FOV of the LIDAR 305 is at 180 degrees will be in alignment with the data captured by the LIDAR 305 when the center of the FOV of the LIDAR 305 is at 180 degrees.

The trigger 330, the trigger 332, and the trigger 334 can each include a signal configured to trigger the sensors 310A, 310B, and 310N, respectively, to capture sensor data. In some example, each trigger (e.g., trigger 330, trigger 332, trigger 334) can include one or more instructions and/or commands configured to trigger a respective sensor (e.g., sensor 310A, sensor 310B, sensor 310N) to capture sensor data. In some cases, each trigger can include a respective time offset that indicates when a sensor should initiate an operation to capture sensor data. For example, the trigger 330 can include a time offset calculated for sensor 310A, which indicates when the sensor 310A should initiate a data capturing operation. The trigger 332 can include a time offset calculated for sensor 310B, which indicates when the sensor 310B should initiate a data capturing operation, and the trigger 334 can include a time offset calculated for sensor 310N, which indicates when the sensor 310N should initiate a data capturing operation. In some cases, the triggers 330, 332, and 334 can include the same time offset. In other cases, the triggers 330, 332, and 334 can include different time offsets, such as respective time offsets specific to sensors 310A, 310B, and 310N.

In some cases, the trigger 330 can be generated and/or sent before a predicted time of FOV alignment for a LIDAR scan, and used to trigger data capturing operations by the sensor 310A when the FOV of the sensor 310 and the FOV of the LIDAR 305 are aligned during the LIDAR scan. In some examples, the trigger 330 can be used by the sensor 310 to trigger data capturing operations at specific times and/or intervals during each LIDAR scan. In other examples, a trigger can be sent to the sensor 310A for each LIDAR scan (e.g., rather than sending to the sensor 310A a trigger used in multiple LIDAR scans to align data capturing operations of the sensor 310A) to provide a time offset to the sensor 310A for each LIDAR scan.

In some cases, the trigger 330 can be sent to the sensor 310A a certain amount before the center of the FOV of the LIDAR 305 is aligned with the center of the FOV of the sensor 310A to account for a delay between the time that the sensor 310A receives the trigger 330 and the time that the sensor 310A begins capturing sensor data. Thus, the timing for sending the trigger 310A can be based on a time offset when the FOV of the LIDAR 305 is predicted to be aligned with the FOV of the sensor 310 and a determined delay between the time that the sensor 310A receives the trigger 330 and the time that the sensor 310A begins capturing sensor data.

For example, if a computing device determines that there is a 1 second delay between the time that the sensor 310A receives the trigger 330 and the time that the sensor 310A begins capturing sensor data and the time offset indicates that the FOV of the LIDAR 305 and the FOV of the sensor 310A are aligned every 10 seconds, the computing device can send the trigger 330 to the sensor 310 every 9 seconds, which includes the 10 seconds indicated in the time offset minus the amount of delay determined for the sensor 310. As another example, if the trigger indicates a time offset and the sensor 310A is configured to use the trigger 330 to trigger data capturing operations during multiple LIDAR scans (e.g., rather than receiving and using a trigger for each LIDAR scan), the time offset can include an amount/interval of time it takes for the FOV of the LIDAR 305 to be aligned with the FOV of the sensor 310A between LIDAR scans (e.g., from when the FOV of the LIDAR 305 is aligned with the FOV of the sensor 310A during the LIDAR scan 320 and the FOV of the LIDAR 305 is aligned with the FOV of the sensor 310A during the LIDAR scan 322) minus a delay between the time that the sensor 310A initiates a data capturing operation and the time that the sensor 310A actually begins capturing sensor data.

In some examples, the trigger 332 can be sent to the sensor 310B a certain amount before the center of the FOV of the LIDAR 305 is aligned with the center of the FOV of the sensor 310B to account for a delay between the time that the sensor 310B receives the trigger 330 and the time that the sensor 310B begins capturing sensor data. In other examples, the trigger 332 can include a time offset predicted for the sensor 310B which includes the amount/interval of time it takes for the FOV of the LIDAR 305 to be aligned with the FOV of the sensor 310B between LIDAR scans (e.g., from when the FOV of the LIDAR 305 is aligned with the FOV of the sensor 310B during the LIDAR scan 320 and the FOV of the LIDAR 305 is aligned with the FOV of the sensor 310B during the LIDAR scan 322) minus a delay between the time that the sensor 310B initiates a data capturing operation and the time that the sensor 310A actually begins capturing sensor data.

In some cases, the trigger 334 can be sent to the sensor 310N a certain amount before the center of the FOV of the LIDAR 305 is aligned with the center of the FOV of the sensor 310N to account for a delay between the time that the sensor 310N receives the trigger 330 and the time that the sensor 310N begins capturing sensor data. In other cases, the trigger 334 can include a time offset predicted for the sensor 310N which includes the amount/interval of time it takes for the FOV of the LIDAR 305 to be aligned with the FOV of the sensor 310N between LIDAR scans (e.g., from when the FOV of the LIDAR 305 is aligned with the FOV of the sensor 310N during the LIDAR scan 320 and the FOV of the LIDAR 305 is aligned with the FOV of the sensor 310N during the LIDAR scan 322) minus a delay between the time that the sensor 310N initiates a data capturing operation and the time that the sensor 310A actually begins capturing sensor data.

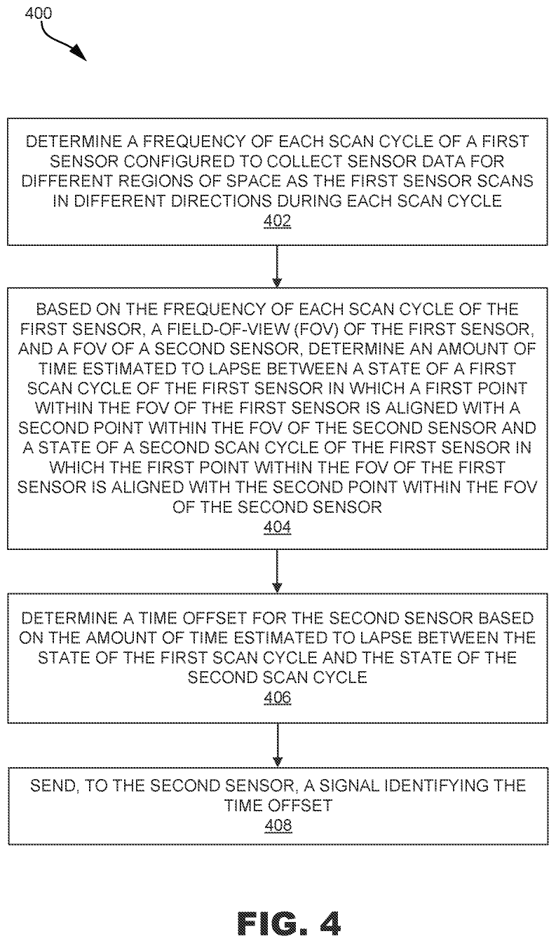

FIG. 4 is a flowchart illustrating an example process 400 for synchronizing data capturing operations of multiple sensors, according to some examples of the present disclosure. At block 402, the process 400 can include determining a frequency of each scan cycle of a first sensor (e.g., LIDAR 202, LIDAR 305) configured to collect sensor data (e.g., LIDAR data) for different regions of space as the first sensor scans in different directions during each scan cycle. For example, the first sensor can include a spinning LIDAR configured to rotate as it collects sensor data during each scan cycle.

At block 404, the process 400 can include determining, based on the frequency of each scan cycle of the first sensor, a FOV of the first sensor, and a FOV of a second sensor (e.g., sensor 204, sensor 310A, sensor 310B, sensor 310N), an amount of time estimated to lapse between a state of a first scan cycle of the first sensor in which a first point within the FOV of the first sensor is aligned with a second point within the FOV of the second sensor and a state of a second scan cycle of the first sensor in which the first point within the FOV of the first sensor is aligned with the second point within the FOV of the second sensor. In other words, the process 400 can estimate an amount of time that it takes the first sensor to reach a scanning position, direction, and/or angle in each scan where the FOV of the first sensor is aligned with the FOV of the second sensor.

In some examples, the first point within the FOV of the first sensor can include a point on a first plane along a center of the FOV of the first sensor, and the second point within the FOV of the second sensor can include a point on a second plane extending from or along a center of the FOV of the second sensor. In some cases, points along the first plane can be equidistant to points along each side/boundary of the FOV of the first sensor, and points along the second plane can be equidistant to points along each side/boundary of the FOV of the second sensor.

In some examples, the first point within the FOV of the first sensor can be on a first plane that extends from a vertex of a first angle of the FOV of the first sensor, and the second point within the FOV of the second sensor can be on a second plane that extends from a vertex of a second angle of the FOV of the second sensor.

In some cases, the state of the first scan cycle and the state of the second scan cycle are associated with a scan direction of the first sensor during the first scan cycle and the second scan cycle. For example, the state of the second scan cycle can be reached when the first sensor captures data from/along a same direction as the first scan cycle.

At block 406, the process 400 can include determining a time offset for the second sensor based on the amount of time estimated to lapse between the state of the first scan cycle and the state of the second scan cycle. For example, the process 400 can determine a time offset used to trigger/time data capture operations of the second sensor based on the amount of time estimated to lapse between the first point within the FOV of the first sensor and the second point within the FOV of the second sensor becoming aligned in different scan cycles of the first sensor.

At block 408, the process 400 can include sending, to the second sensor, a signal identifying the time offset. In some examples, the signal can identify the time offset and can be configured to trigger the second sensor to capture sensor data at or after specific time intervals defined by the time offset. In some cases, each specific time interval of the specific time intervals can include the amount of time estimated to lapse between the state of the first scan cycle and the state of the second scan cycle.

In some aspects, the process 400 can include determining a time delay between a first time when the second sensor initiates an operation to capture the sensor data and a second time when the second sensor captures the sensor data. In some examples, each specific time interval of the specific time intervals can include the amount of time estimated to lapse between the state of the first scan cycle and the state of the second scan cycle minus the time delay.

In some aspects, the first sensor can include a spinning LIDAR sensor, and the scan cycle can include a cycle of rotation performed by the spinning LIDAR sensor while collecting sensor data. In some examples, the second sensor can include a camera sensor, a RADAR sensor, a TOF sensor, or a LIDAR sensor. In some aspects, the first sensor and the second sensor can be mounted on a vehicle. For example, the first and second sensor can be mounted on AV 102 and used by AV 102 to collect sensor data in an environment.

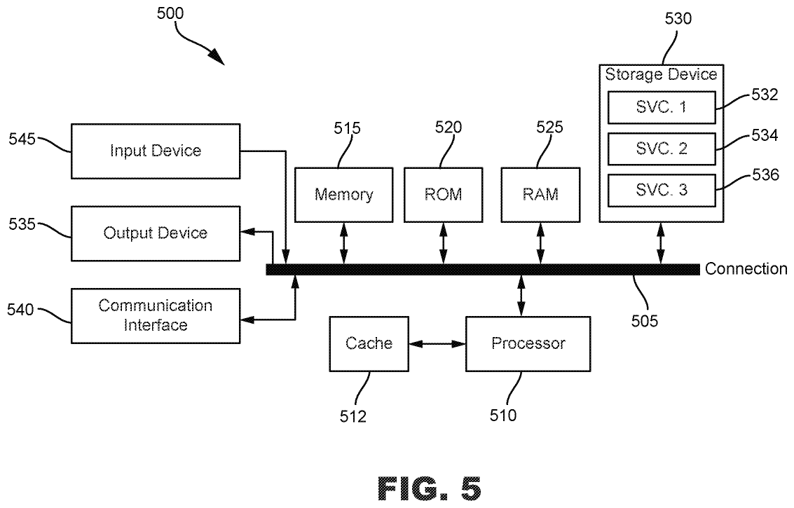

FIG. 5 illustrates an example processor-based system with which some aspects of the subject technology can be implemented. For example, processor-based system 500 can be any computing device making up local computing device 110, data center 150, a passenger device executing the ridehailing application 172, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some examples, computing system 500 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, and/or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 can include an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, causes the system to perform a function. In some examples, a hardware service that performs a particular function can include the software component stored in a computer-readable medium in connection with the necessary hardware components, such as processor 510, connection 505, output device 535, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: memory and one or more processors coupled to the memory, the one or more processors configured to: determine a frequency of each scan cycle of a first sensor configured to collect sensor data for different regions of space as the first sensor scans in different directions during each scan cycle; based on the frequency of each scan cycle of the first sensor, a field-of-view (FOV) of the first sensor, and a FOV of a second sensor, determine an amount of time estimated to lapse between a state of a first scan cycle of the first sensor in which a first point within the FOV of the first sensor is aligned with a second point within the FOV of the second sensor and a state of a second scan cycle of the first sensor in which the first point within the FOV of the first sensor is aligned with the second point within the FOV of the second sensor; determine a time offset for the second sensor based on the amount of time estimated to lapse between the state of the first scan cycle state and the state of the second scan cycle; and send, to the second sensor, a signal identifying the time offset, wherein the signal identifying the time offset is configured to trigger the second sensor to capture sensor data at or after specific time intervals defined by the time offset.

Aspect 2. The system of Aspect 1, wherein each specific time interval of the specific time intervals comprises the amount of time estimated to lapse between the state of the first scan cycle and the state of the second scan cycle.

Aspect 3. The system of any of Aspects 1 or 2, wherein the one or more processors are configured to: determine a time delay between a first time when the second sensor initiates an operation to capture the sensor data and a second time when the second sensor captures the sensor data, wherein each specific time interval of the specific time intervals comprises the amount of time estimated to lapse between the state of the first scan cycle and the state of the second scan cycle minus the time delay.

Aspect 4. The system of any of Aspects 1 to 3, wherein the first point within the FOV of the first sensor is on a first plane along a center of the FOV of the first sensor, and wherein the second point within the FOV of the second sensor is on a second plane extending from or along a center of the FOV of the second sensor.

Aspect 5. The system of any of Aspects 1 to 4, wherein the first point within the FOV of the first sensor is on a first plane that extends from a vertex of a first angle of the FOV of the first sensor, and wherein the second point within the FOV of the second sensor is on a second plane that extends from a vertex of a second angle of the FOV of the second sensor.

Aspect 6. The system of any of Aspects 1 to 5, wherein the state of the first scan cycle and the state of the second scan cycle are associated with a scan direction of the first sensor during the first scan cycle and the second scan cycle.

Aspect 7. The system of any of Aspects 1 to 6, wherein the first sensor comprises a spinning light detection and ranging (LIDAR) sensor, and wherein each scan cycle comprises a cycle of rotation performed by the spinning LIDAR sensor while collecting sensor data.

Aspect 8. The system of any of Aspects 1 to 7, wherein the second sensor comprises a camera sensor, a radio detection and ranging (RADAR) sensor, a time-of-flight (TOF) sensor, or a light detection and ranging (LIDAR) sensor.

Aspect 9. The system of any of Aspects 1 to 8, wherein the first sensor and the second sensor are mounted on a vehicle.

Aspect 10. A method comprising: determining a frequency of each scan cycle of a first sensor configured to collect sensor data for different regions of space as the first sensor scans in different directions during each scan cycle; based on the frequency of each scan cycle of the first sensor, a field-of-view (FOV) of the first sensor, and a FOV of a second sensor, determining an amount of time estimated to lapse between a state of a first scan cycle of the first sensor in which a first point within the FOV of the first sensor is aligned with a second point within the FOV of the second sensor and a state of a second scan cycle of the first sensor in which the first point within the FOV of the first sensor is aligned with the second point within the FOV of the second sensor; determining a time offset for the second sensor based on the amount of time estimated to lapse between the state of the first scan cycle and the state of the second scan cycle; and sending, to the second sensor, a signal identifying the time offset, wherein the signal identifying the time offset is configured to trigger the second sensor to capture sensor data at or after specific time intervals defined by the time offset.

Aspect 11. The method of Aspect 10, wherein each specific time interval of the specific time intervals comprises the amount of time estimated to lapse between the state of the first scan cycle and the state of the second scan cycle.

Aspect 12. The method of any of Aspects 10 or 11, further comprising: determining a time delay between a first time when the second sensor initiates an operation to capture the sensor data and a second time when the second sensor captures the sensor data, wherein each specific time interval of the specific time intervals comprises the amount of time estimated to lapse between the state of the first scan cycle and the state of the second scan cycle minus the time delay.

Aspect 13. The method of any of Aspects 10 to 12, wherein the first point within the FOV of the first sensor is on a first plane along a center of the FOV of the first sensor, and wherein the second point within the FOV of the second sensor is on a second plane extending from or along a center of the FOV of the second sensor.

Aspect 14. The method of any of Aspects 10 to 13, wherein the first point within the FOV of the first sensor is on a first plane that extends from a vertex of a first angle of the FOV of the first sensor, and wherein the second point within the FOV of the second sensor is on a second plane that extends from a vertex of a second angle of the FOV of the second sensor.

Aspect 15. The method of any of Aspects 10 to 14, wherein the state of the first scan cycle and the state of the second scan cycle are associated with a scan direction of the first sensor during the first scan cycle and the second scan cycle.

Aspect 16. The method of any of Aspects 10 to 15, wherein the first sensor comprises a spinning light detection and ranging (LIDAR) sensor, and wherein the scan cycle comprises a cycle of rotation performed by the spinning LIDAR sensor while collecting sensor data.

Aspect 17. The method of any of Aspects 10 to 16, wherein the second sensor comprises a camera sensor, a radio detection and ranging (RADAR) sensor, a time-of-flight (TOF) sensor, or a light detection and ranging (LIDAR) sensor.

Aspect 18. The method of any of Aspects 10 to 17, wherein the first sensor and the second sensor are mounted on a vehicle.

Aspect 19. A non-transitory computer-readable medium having stored thereon instructions which, when executed by one or more processors, cause the one or more processors to perform a method according to any of Aspects 10 to 18.

Aspect 20. A system comprising means for performing a method according to any of Aspects 10 to 18.

Aspect 21. The system of Aspect 20, further comprising the first sensor and/or the second sensor.

Aspect 22. A vehicle comprising a computing device configured to perform a method according to any of Aspects 10 to 18.

Aspect 23. The vehicle of Aspect 22, further comprising the first sensor and/or the second sensor.

Aspect 24. A computer-program product comprising instructions which, when executed by one or more computing devices, cause the one or more computing devices to perform a method according to any of Aspects 10 to 18.

What is claimed is:

1. A system comprising:
a memory; and
one or more processors coupled to the memory, the one or more processors being configured to:
determine a frequency of each scan cycle of a first sensor configured to collect sensor data for different regions of space as the first sensor scans in different directions during each scan cycle;
based on the frequency of each scan cycle of the first sensor, a field-of-view (FOV) of the first sensor, and a FOV of a second sensor, determine an amount of time estimated to lapse between a state of a first scan cycle of the first sensor in which a first point within the FOV of the first sensor is aligned with a second point within the FOV of the second sensor and a state of a second scan cycle of the first sensor in which the first point within the FOV of the first sensor is aligned with the second point within the FOV of the second sensor;
determine a time offset for the second sensor based on the amount of time estimated to lapse between the state of the first scan cycle state and the state of the second scan cycle; and
send, to the second sensor, a signal identifying the time offset, wherein the signal identifying the time offset is configured to trigger the second sensor to capture sensor data at or after specific time intervals defined by the time offset.

2. The system of claim 1, wherein each specific time interval of the specific time intervals comprises the amount of time estimated to lapse between the state of the first scan cycle and the state of the second scan cycle.

3. The system of claim 1, wherein the one or more processors are configured to:
determine a time delay between a first time when the second sensor initiates an operation to capture the sensor data and a second time when the second sensor captures the sensor data, wherein each specific time interval of the specific time intervals comprises the amount of time estimated to lapse between the state of the first scan cycle and the state of the second scan cycle minus the time delay.

4. The system of claim 1, wherein the first point within the FOV of the first sensor is on a first plane along a center of the FOV of the first sensor, and wherein the second point within the FOV of the second sensor is on a second plane extending from or along a center of the FOV of the second sensor.

5. The system of claim 1, wherein the first point within the FOV of the first sensor is on a first plane that extends from a vertex of a first angle of the FOV of the first sensor, and wherein the second point within the FOV of the second sensor is on a second plane that extends from a vertex of a second angle of the FOV of the second sensor.

6. The system of claim 1, wherein the state of the first scan cycle and the state of the second scan cycle are associated with a scan direction of the first sensor during the first scan cycle and the second scan cycle.

7. The system of claim 1, wherein the first sensor comprises a spinning light detection and ranging (LIDAR) sensor, and wherein each scan cycle comprises a cycle of rotation performed by the spinning LIDAR sensor while collecting sensor data.

8. The system of claim 1, wherein the second sensor comprises a camera sensor, a radio detection and ranging (RADAR) sensor, a time-of-flight (TOF) sensor, or a light detection and ranging (LIDAR) sensor.

9. The system of claim 1, wherein the first sensor and the second sensor are mounted on a vehicle.

10. A method comprising:
determining a frequency of each scan cycle of a first sensor configured to collect sensor data for different regions of space as the first sensor scans in different directions during each scan cycle;
based on the frequency of each scan cycle of the first sensor, a field-of-view (FOV) of the first sensor, and a FOV of a second sensor, determining an amount of time estimated to lapse between a state of a first scan cycle of the first sensor in which a first point within the FOV of the first sensor is aligned with a second point within the FOV of the second sensor and a state of a second scan cycle of the first sensor in which the first point within the FOV of the first sensor is aligned with the second point within the FOV of the second sensor;
determining a time offset for the second sensor based on the amount of time estimated to lapse between the state of the first scan cycle and the state of the second scan cycle; and
sending, to the second sensor, a signal identifying the time offset, wherein the signal identifying the time offset is configured to trigger the second sensor to capture sensor data at or after specific time intervals defined by the time offset.

11. The method of claim 10, wherein each specific time interval of the specific time intervals comprises the amount of time estimated to lapse between the state of the first scan cycle and the state of the second scan cycle.

12. The method of claim 10, further comprising:
determining a time delay between a first time when the second sensor initiates an operation to capture the sensor data and a second time when the second sensor captures the sensor data, wherein each specific time interval of the specific time intervals comprises the amount of time estimated to lapse between the state of the first scan cycle and the state of the second scan cycle minus the time delay.

13. The method of claim 10, wherein the first point within the FOV of the first sensor is on a first plane along a center of the FOV of the first sensor, and wherein the second point within the FOV of the second sensor is on a second plane extending from or along a center of the FOV of the second sensor.

14. The method of claim 10, wherein the first point within the FOV of the first sensor is on a first plane that extends from a vertex of a first angle of the FOV of the first sensor, and wherein the second point within the FOV of the second sensor is on a second plane that extends from a vertex of a second angle of the FOV of the second sensor.

15. The method of claim 10, wherein the state of the first scan cycle and the state of the second scan cycle are associated with a scan direction of the first sensor during the first scan cycle and the second scan cycle.

16. The method of claim 10, wherein the first sensor comprises a spinning light detection and ranging (LIDAR) sensor, and wherein the scan cycle comprises a cycle of rotation performed by the spinning LIDAR sensor while collecting sensor data.

17. The method of claim 10, wherein the second sensor comprises a camera sensor, a radio detection and ranging (RADAR) sensor, a time-of-flight (TOF) sensor, or a light detection and ranging (LIDAR) sensor.

18. The method of claim 10, wherein the first sensor and the second sensor are mounted on a vehicle.

19. A non-transitory computer-readable medium having stored thereon instructions which, when executed by one or more processors, cause the one or more processors to:
determine a frequency of each scan cycle of a first sensor configured to collect sensor data for different regions of space as the first sensor scans in different directions during each scan cycle;
based on the frequency of each scan cycle of the first sensor, a field-of-view (FOV) of the first sensor, and a FOV of a second sensor, determine an amount of time estimated to lapse between a state of a first scan cycle of the first sensor in which a first point within the FOV of the first sensor is aligned with a second point within the FOV of the second sensor and a state of a second scan cycle of the first sensor in which the first point within the FOV of the first sensor is aligned with the second point within the FOV of the second sensor;
determine a time offset for the second sensor based on the amount of time estimated to lapse between the state of the first scan cycle and the state of the second scan cycle; and
send, to the second sensor, a signal identifying the time offset, wherein the signal identifying the time offset is configured to trigger the second sensor to capture sensor data at or after specific time intervals defined by the time offset.

20. The non-transitory computer-readable medium of claim 19, wherein the instructions, when executed by the one or more processors, cause the one or more processors to:
determine a time delay between a first time when the second sensor initiates an operation to capture the sensor data and a second time when the second sensor captures the sensor data, wherein each specific time interval of the specific time intervals comprises the amount of time estimated to lapse between the state of the first scan cycle and the state of the second scan cycle minus the time delay.
